(19) United States
(12) Patent Application Publication
(10) Pub. No.: US 2022/0021047 A1
(43) Pub. Date: Jan. 20, 2022

(54) NON-AQUEOUS ELECTROLYTE SECONDARY BATTERY

(71) Applicant: TOYOTA JIDOSHA KABUSHIKI KAISHA, Toyota-shi (JP)

(72) Inventors: Kensaku MIYAZAWA, Toyota-shi (JP); Masaki KATO, Zushi-shi (JP); Akira KIYAMA, Toyota-shi (JP); Sho ANDO, Seto-shi (JP); Kunimitsu YAMAMOTO, Kasugai-shi (JP); Koshiro YONEDA, Ichinomiya-shi (JP)

(73) Assignee: TOYOTA JIDOSHA KABUSHIKI KAISHA, Toyota-shi (JP)

(21) Appl. No.: 17/354,697

(22) Filed: Jun. 22, 2021

(30) Foreign Application Priority Data
Jul. 17, 2020 (JP) 2020-122776

(51) Int. Cl. H01M 10/6551; H01M 10/613; H01M 10/647; H01M 4/485; H01M 4/58

(52) U.S. Cl. CPC H01M 10/6551; H01M 10/613; H01M 2004/027; H01M 4/485; H01M 4/5825; H01M 10/647

(57) ABSTRACT

A cell that is a non-aqueous electrolyte secondary battery includes an electrode body in which a sheet-shaped positive electrode and a sheet-shaped negative electrode are stacked via a separator, and a battery case that accommodates the electrode body and an electrolytic solution. The electrode body includes a predetermined number of outer layers including an outermost layer made up of the separator and the negative electrode disposed on an outermost side of the electrode body, and an inner layer disposed on an inner side than the outer layer. The outer layer includes a negative electrode mixture layer configured to suppress heat generation of the electrode body caused by a short circuit of the electrode body as a heat generation suppressing member. The inner layer does not include the heat generation suppressing member.

### CROSS-REFERENCE TO RELATED APPLICATION

This application claims priority to Japanese Patent Application No. 2020-122776 filed on Jul. 17, 2020, incorporated herein by reference in its entirety.

### BACKGROUND

### 1. Technical Field

The present disclosure relates to a non-aqueous electrolyte secondary battery.

### 2. Description of Related Art

In recent years, the demand for a lithium-ion secondary battery has been increasing as a traveling power source for hybrid vehicles, plug-in hybrid vehicles, electric vehicles, and the like. A typical lithium-ion secondary battery for an automobile includes an electrode body in which a positive electrode and a negative electrode are wound via a separator, and a battery case that accommodates the electrode body (see, for example, Japanese Unexamined Patent Application Publication No. 2019-186156 (JP 2019-186156 A)).

### SUMMARY

In a manufacturing process of the lithium-ion secondary battery, metal foreign matter may be mixed into the battery case. When the metal foreign matter is mixed, the electrode body may short-circuit and generate heat, resulting in thermal runaway. Therefore, a measure to suppress heat generation is taken. On the other hand, in a case where an excessive measure is taken, adverse effects, such as a decrease in an energy density of the lithium-ion secondary battery and an increase in a size of the lithium-ion secondary battery may occur.

The present disclosure provides a non-aqueous electrolyte secondary battery in which heat generation (particularly thermal runaway) due to a short circuit of an electrode body is suppressed while adverse effects, such as a decrease in an energy density or an increase in a size are prevented.

(1) An aspect of the present disclosure relates to a non-aqueous electrolyte secondary battery. The non-aqueous electrolyte secondary battery includes an electrode body in which a positive electrode and a negative electrode are stacked via a separator, and a battery case that accommodates the electrode body and an electrolytic solution. The electrode body includes a predetermined number of outer layers including an outermost layer made up of the separator and the negative electrode disposed on an outermost side of the electrode body, and an inner layer disposed on an inner side than the outer layer. The outer layer includes a heat generation suppressing member configured to suppress heat generation of the electrode body caused by a short circuit of the electrode body. The inner layer does not include the heat generation suppressing member.

According to the configuration of (1), the heat generation caused by the short circuit of the electrode body can be suppressed by providing the heat generation suppressing member. Further, since the heat generation suppressing member is provided partially rather than entirely in the electrode body, adverse effects, such as a decrease in an energy density or an increase in a size can be prevented.

(2) In the non-aqueous electrolyte secondary battery according to the first aspect, the negative electrode may include a negative electrode body and a negative electrode mixture layer. The heat generation suppressing member may include a negative electrode mixture layer containing lithium titanium oxide.

In the configuration of (2), the heat generation suppressing member is the negative electrode mixture layer containing lithium titanium oxide. Lithium titanium oxide has higher electric resistance than graphite-based materials, and is difficult for a short-circuit current to flow. Therefore, according to the configuration of (2), the heat generation caused by the short circuit of the electrode body can be suitably suppressed.

(3) In the non-aqueous electrolyte secondary battery according to the first aspect, the heat generation suppressing member may include a heat resistance layer provided on the separator.

(4) In the non-aqueous electrolyte secondary battery according to the first aspect, the battery case may be a square case. The electrode body may have an outer shape of a flat rectangular parallelepiped, and be accommodated in the battery case such that the long side of the flat rectangular parallelepiped may extend in the long side direction of the battery case. The heat resistance layer may be locally provided in a central region of the electrode body in the long side direction of the electrode body.

(5) In the non-aqueous electrolyte secondary battery according to the first aspect, the heat resistance layer may be a resin film having heat resistance. (6) In the non-aqueous electrolyte secondary battery according to the first aspect, the heat resistance layer may be a ceramic having heat resistance. (7) In the non-aqueous electrolyte secondary battery according to the first aspect, the heat resistance layer may be an active material containing at least one of lithium titanate and lithium iron phosphate. (8) In the non-aqueous electrolyte secondary battery according to the first aspect, the heat resistance layer may be a separator added to the central region.

In the configurations of (3) to (8), the heat generation suppressing member is the heat resistance layer provided on the separator. The electrode body is less likely to be damaged even when the electrode body becomes hot due to heat generation, by adding the heat resistance layer. Therefore, according to the configurations of (3) to (8), the heat generation caused by the short circuit of the electrode body can be suitably suppressed.

According to the present disclosure, the heat generation due to the short circuit of an electrode body can be suppressed while the adverse effects, such as a decrease in an energy density or an increase in a size can be prevented.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing an example of a configuration of a lithium-ion secondary battery according to a first embodiment;

FIG. 2 is a perspective view schematically showing another example of the configuration of the lithium-ion secondary battery according to the first embodiment;

FIG. 3 is a view showing an example of a configuration of an electrode body according to the first embodiment;

FIG. 4 is a view schematically showing a cross section of the electrode body taken along the line IV-IV of FIG. 3;

FIG. 5 is a view schematically showing another example of the cross section of the electrode body;

FIG. 6 is a table summarizing results of an evaluation test of a cell according to the first embodiment;

FIG. 7 is a view showing an example of a configuration of an electrode body according to a second embodiment;

FIG. 8 is a view schematically showing a cross section of the electrode body taken along the line VIII-VIII of FIG. 7; and

FIG. 9 is a table summarizing results of an evaluation test of a cell according to the second embodiment.

### DETAILED DESCRIPTION OF EMBODIMENTS

Hereinafter, embodiments of the present disclosure will be described in detail with reference to the drawings. The same or similar portions in the drawings are represented by the same reference signs, and description thereof will not be repeated.

### First Embodiment

In the following first embodiment, a lithium-ion secondary battery is adopted as an exemplary embodiment of the non-aqueous electrolyte secondary battery according to the present disclosure.

Overall Configuration of Lithium-Ion Secondary Battery

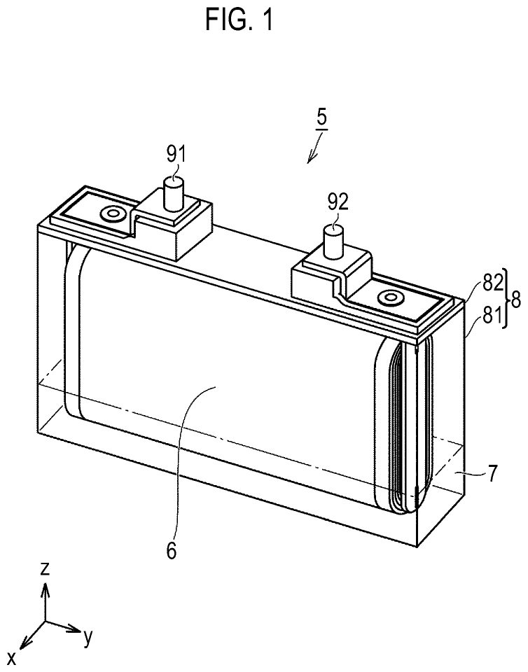

FIG. 1 is a perspective view schematically showing an example of a configuration of a lithium-ion secondary battery according to a first embodiment. In the following description, the lithium-ion secondary battery according to the first embodiment will be referred to as a cell 5. For ease of understanding, a perspective view of an interior of the cell 5 is shown in FIG. 1.

The cell 5 is a sealed square battery in this example. Note that, the shape of the cell 5 is not limited to the square shape, and may be, for example, a cylindrical shape. The cell 5 includes an electrode body 6, an electrolytic solution 7, and a battery case 8.

The electrode body 6 shown in FIG. 1 is a winding type. That is, the electrode body 6 is formed by alternately stacking a positive electrode 1 and a negative electrode 2 via a separator 3 sandwiched therebetween, and further winding the stacked body in a tubular shape.

The electrolytic solution 7 is injected into the battery case 8 and the electrode body 6 is impregnated with the electrolytic solution 7. In FIG. 1, the liquid level of the electrolytic solution 7 is shown by an alternate long and short dash line. The detailed configuration, such as materials used for the electrode body 6 (positive electrode 1, negative electrode 2, and separator 3) and the electrolytic solution 7 will be described later.

The battery case 8 may be made of an aluminum (Al) alloy or the like. Note that, the battery case 8 may be a pouch made of an Al laminate film as long as the battery case 8 can be sealed. The battery case 8 includes a case body 81 and a lid 82.

The case body 81 accommodates the electrode body 6 and the electrolytic solution 7. The case body 81 has an outer shape of a flat rectangular parallelepiped. The case body 81 and the lid 82 are joined by, for example, laser welding. The lid 82 is provided with a positive electrode terminal 91 and a negative electrode terminal 92. Although not shown, the lid 82 may be further provided with a liquid injection port, a gas discharge valve, a current interrupt device (CID), and the like.

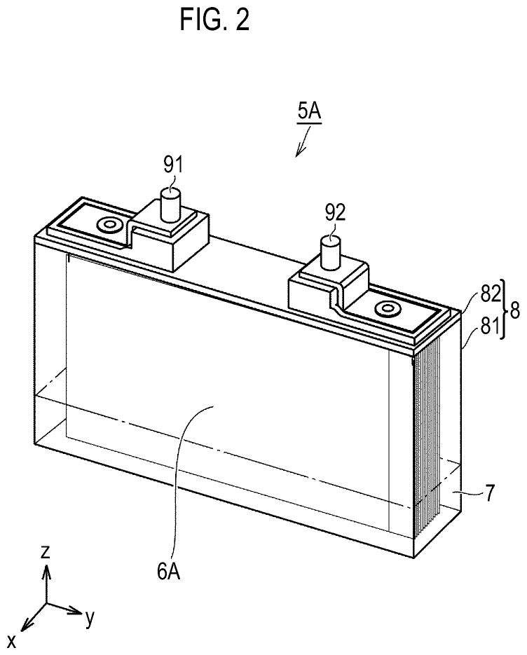

FIG. 2 is a perspective view schematically showing another example of the configuration of the lithium-ion secondary battery according to the first embodiment. With reference to FIG. 2, a cell 5A is different from the cell 5 shown in FIG. 1 in that the cell 5A includes a stack type electrode body 6A instead of the winding type electrode body 6. The stack type electrode body 6A is formed by alternately stacking a positive electrode and a negative electrode via a separator sandwiched therebetween.

In the following description, the winding type electrode body 6 will be described as an example, but the same configuration as the following description may be applied to the stack type electrode body 6A. In general, since production of a stack type electrode body is easier than production of a winding type electrode body, production efficiency can be improved with application to the stack type electrode body 6A.

Shape of Electrode Body

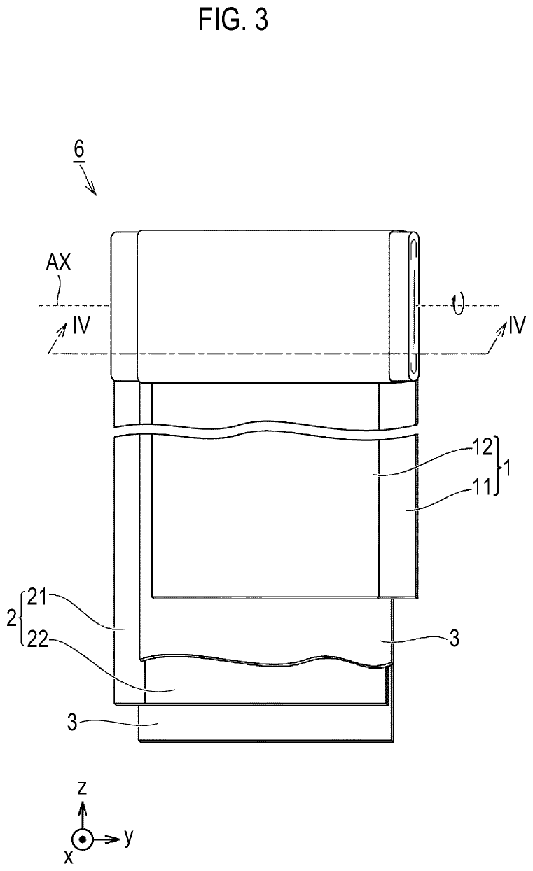

FIG. 3 is a view showing an example of a configuration of the electrode body 6 according to the first embodiment. As shown in FIG. 3, the electrode body 6 has an outer shape of a flat rectangular parallelepiped like the battery case 8 (case body 81). The electrode body 6 is accommodated in the battery case 8 such that the long side of the flat rectangular parallelepiped (side in a right and left direction (y-direction) in drawings) extends in the long side direction of the battery case 8 (see FIG. 2).

The electrode body 6 can be formed in detail as follows. First, a stacked body is obtained by stacking the positive electrode 1, the separator 3, the negative electrode 2, and the separator 3 in this order. The stacked body is wound around a winding axis AX in a tubular shape to obtain a wound body. Then, the wound body is formed in a flat shape by being pressed in a side surface direction (front-depth direction of papers: x-direction). For the sake of description, FIG. 3 shows a state during winding.

Positive Electrode

The positive electrode 1 is a belt-shaped sheet. The positive electrode 1 includes a positive electrode current collector 11 and a positive electrode mixture layer 12. The positive electrode current collector 11 may be an aluminum (Al) foil, an Al alloy foil, or the like. The positive electrode current collector 11 is electrically connected to the positive electrode terminal 91 (see FIG. 1). In the direction (y-direction) in which the winding axis AX extends shown in FIG. 3, a portion of the positive electrode current collector 11 protruding from the positive electrode mixture layer 12 is used for electrical connection to the positive electrode terminal 91 (see FIG. 1).

The positive electrode mixture layer 12 is formed on a surface of the positive electrode current collector 11. The positive electrode mixture layer 12 may be formed on both front surface and back surface of the positive electrode current collector 11. The positive electrode mixture layer 12 contains a positive electrode active material, a conductive material, a binder, and a flame retardant (none of which are shown).

The positive electrode active material may be, for example, LiCoO₂, LiNiO₂, LiNi_{1/3}Co_{1/3}Mn_{1/3}O₂ (NCM), LiNi_{0.8}Co_{0.15}Al_{0.05}O₂ (NCA), LiMnO₂, LiMn₂O₄, or LiFePO₄. Two or more kinds of positive electrode active materials may be used in combination.

The conductive material may be, for example, acetylene black (AB), furnace black, vapor-grown carbon fiber (VGCF), or graphite.

The binder may be, for example, polyvinylidene difluoride (PVdF), styrene butadiene rubber (SBR), or polytetrafluoroethylene (PTFE).

The flame retardant is not particularly limited as long as the flame retardant contains phosphorus (P) or sulfur (S) and has a thermal decomposition temperature of 80° C. or higher and 210° C. or lower. The flame retardant may be, for example, guanidine sulfamate, guanidine phosphate, guanylurea phosphate, diammonium phosphate, ammonium polyphosphate, ammonium sulfamate, melamine cyanurate, bisphenol A bis (diphenyl phosphate ester), resorcinol bis (diphenyl phosphate ester), triisopropyl phenyl phosphate ester, triphenyl phosphate ester, trimethyl phosphate ester, triethyl phosphate ester, tricresyl phosphate ester, tris(chloroisopropyl)phosphate ester, (C₄H₉)₃PO), (HO—C₃H₆)₃PO, a phosphazene compound, phosphorus pentoxide, polyphosphoric acid, or melamine. These flame retardants may be used alone or two or more kinds of flame retardants may be used in combination.

Negative Electrode

The negative electrode 2 is a belt-shaped sheet. The negative electrode 2 includes a negative electrode mixture layer 22 and a negative electrode current collector 21. The negative electrode current collector 21 is electrically connected to the negative electrode terminal 92. The negative electrode current collector 21 may be, for example, a copper (Cu) foil.

The negative electrode mixture layer 22 is formed on a surface of the negative electrode current collector 21. The negative electrode mixture layer 22 may be formed on both front surface and back surface of the negative electrode current collector 21. The negative electrode mixture layer 22 contains a negative electrode active material and a binder.

The negative electrode active material is a graphite-based material (hereinafter, also referred to as carbon). Specifically, the negative electrode active material may be amorphous coated graphite (a form in which a surface of a graphite particle is coated with amorphous carbon), graphite, easily graphitizable carbon, or non-graphitizable carbon.

The binder may be, for example, carboxymethyl cellulose (CMC), styrene butadiene rubber (SBR).

Separator

The separator 3 is a belt-shaped film. The separator 3 is disposed between the positive electrode 1 and the negative electrode 2, and electrically insulates the positive electrode 1 and the negative electrode 2. A material of the separator 3 may be a porous material, for example, polyethylene (PE) or polypropylene (PP).

The separator 3 may have a single-layer structure. For example, the separator 3 may be formed solely of a porous film made of polyethylene (PE). On the other hand, the separator 3 may have a multi-layer structure. For example, the separator 3 may have a three-layer structure consisting of a porous film made of first polypropylene (PP), a porous film made of polyethylene (PE), and a porous film made of second polypropylene (PP).

Electrolytic Solution

The electrolytic solution 7 contains at least a lithium (Li) salt and a solvent. The Li salt is a supporting electrolyte dissolved in a solvent. The Li salt may be, for example, LiPF₆, LiBF₄, Li[N(FSO₂)₂], or Li[N(CF₃SO₂)₂]. One kind of the Li salt may be used alone or two or more kinds of Li salts may be used in combination.

The solvent is an aprotic solvent. The solvent may be, for example, a mixture of a cyclic carbonate and a chain carbonate.

The cyclic carbonate may be ethylene carbonate (EC), propylene carbonate (PC), butylene carbonate (BC), fluoroethylene carbonate (FEC), or the like. One kind of the cyclic carbonate may be used alone. Two or more kinds of cyclic carbonates may be used in combination.

The chain carbonate may be dimethyl carbonate (DMC), ethyl methyl carbonate (EMC), diethyl carbonate (DEC), or the like. One kind of the chain carbonate may be used alone. Two or more kinds of chain carbonates may be used in combination.

The solvent may include a lactone, a cyclic ether, a chain ether, a carboxylic acid ester, or the like. The lactone may be γ-butyrolactone (GBL), δ-valerolactone, or the like. The cyclic ether may be tetrahydrofuran (THF), 1,3-dioxolane, 1,4-dioxane, or the like. The chain ether may be 1,2-dimethoxyethane (DME) or the like. The carboxylic acid ester may be methylformate (MF), methylacetate (MA), methylpropionate (MP), or the like.

The electrolytic solution 7 may further contain various functional additives in addition to the Li salt and the solvent. Examples of the functional additive include a gas generating agent (overcharge additive), a solid electrolyte interface (SEI) film forming agent. The gas generating agent may be, for example, cyclohexylbenzene (CHB) or biphenyl (BP). Examples of the SEI film forming agent include vinylene carbonate (VC), vinyl ethylene carbonate (VEC), Li[B(C₂O₄)₂], LiPO₂F₂, propane sultone (PS), or ethylene sulfite (ES).

Mixing of Metal Foreign Matter

Generally, it is known that in a manufacturing process of the lithium-ion secondary battery, metal foreign matter may be mixed into the battery case. A specific example will be described using the cell 5, for example, a metal piece (spatter) may be generated when end portions of the positive electrode current collector 11 and the negative electrode current collector 21 are joined by laser welding. In addition, the metal piece may be also generated when the case body 81 and the lid 82 are laser welded, after the electrode body 6 is accommodated in the case body 81. Further, in addition to the manufacturing process of the cell 5, the metal piece may be also generated when an impact is applied to the cell 5 due to a collision of a vehicle equipped with the cell 5.

When the metal foreign matter is mixed, the metal foreign matter adheres to the electrode body 6, so that the electrode body 6 may short-circuit. Then, the electrode body 6 generates heat, and in some cases, thermal runaway may occur. Therefore, a measure to suppress heat generation (thermal runaway) is taken. On the other hand, in a case where an excessive measure is taken, adverse effects, such as a decrease in an energy density of the cell 5 or an increase in a size of the cell 5 may occur.

The present inventors have focused on the fact that when the metal foreign matter causes a short circuit in the electrode body 6, the short circuit occurs in an outermost peripheral portion of the electrode body 6. In the first embodiment, a resistance to the short circuit of the electrode body 6 caused by mixing of metal foreign matter is improved by adopting LTO as a material of a layer including the negative electrode 2 disposed at an outermost periphery of the electrode body 6. Note that, the layer containing LTO is not limited to the layer at the outermost periphery (outermost layer), and may be a predetermined number of layers including the outermost layer.

Configuration of Electrode Body

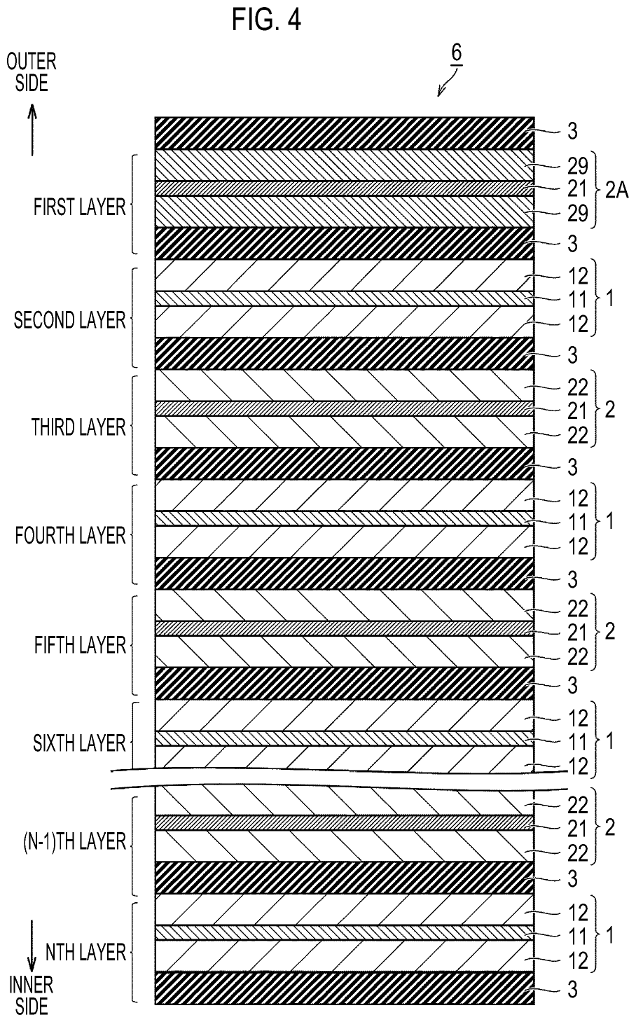

FIG. 4 is a view schematically showing a cross section of the electrode body 6 taken along the line IV-IV of FIG. 3. FIG. 4 shows a stacked structure of the positive electrode 1, the negative electrode 2, and the separator 3 constituting the electrode body 6, from the outer side to the inner side of the electrode body 6. The outer side of the electrode body 6 is a side close to the battery case 8.

The separator 3 and the negative electrode 2A disposed on the outermost side are referred to as a “first layer” (=outermost layer). The separator 3 and the positive electrode 1 disposed second from the outer side are referred to as a “second layer”. The separator 3 and the negative electrode 2 disposed third from the outer side are referred to as a “third layer”. The separator 3 and the positive electrode 1 disposed fourth from the outer side are referred to as a “fourth layer”. The same applies to a fifth layer and subsequent layers.

In the present embodiment, the negative electrode mixture layer 22 of the negative electrode 2 constituting the third layer and the fifth layer (and subsequent odd-numbered layers) contains a graphite-based material (carbon) as the negative electrode active material.

On the other hand, the negative electrode mixture layer 29 of the negative electrode 2A constituting the first layer contains lithium titanium oxide (LTO) as a negative electrode active material, in addition to or instead of a graphite-based material. LTO is a composite oxide containing lithium (Li) and titanium (Ti), and may have various chemical compositions. LTO may have, for example, a chemical composition of Li₄Ti₅O₁₂. The negative electrode mixture layer 29 corresponds to the “heat generation suppressing member” according to the present disclosure.

Atypical negative electrode active material used in a lithium-ion secondary battery is a graphite-based material. A graphite-based material is known as a material having high conductivity (in other words, a material having low electric resistance). Therefore, when a short circuit occurs in a negative electrode using a graphite-based material, a relatively large short-circuit current easily flows through the graphite-based material. Therefore, an amount of heat generated when the short circuit occurs becomes large, and thermal runaway may occur.

In contrast, LTO may have a property that electric resistance increases in a state where lithium ions are desorbed, because of the structure. Also, it is considered that lithium ions are desorbed from LTO when a short circuit occurs. Therefore, the electric resistance can be increased by mixing LTO with the graphite-based material, so that the short-circuit current when a short circuit occurs can be reduced. As a result, the amount of heat generated when the short circuit occurs can be reduced, and thermal runaway can be suppressed.

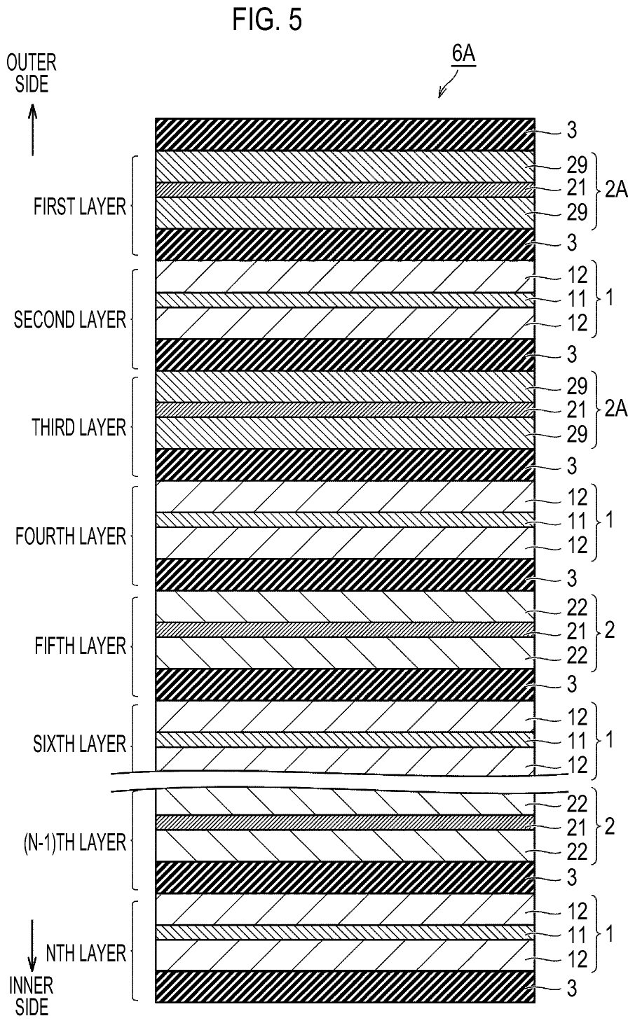

FIG. 5 is a view schematically showing another example of the cross section of the electrode body 6. In FIG. 4, the example in which the negative electrode mixture layer 29 containing LTO as the negative electrode active material is provided solely in the first layer is shown and described. In the example of FIG. 4, solely the first layer corresponds to the “outer layer” according to the present disclosure, and the third layer or the layer of inner side than the third layer corresponds to the “inner layer”. However, as shown in FIG. 5, the negative electrode mixture layer 29 may be provided in the first layer and the third layer, for example. In the example of FIG. 5, the first layer and the third layer correspond to the “outer layer” according to the present disclosure, and the fifth layer or the layer of inner side than the fifth layer corresponds to the “inner layer”.

Although not shown, the negative electrode mixture layer 29 may be provided in three or more layers. In evaluation tests described below, a configuration in which the negative electrode mixture layer 29 is provided in three layers (first layer, third layer, and fifth layer) is also adopted. Note that, it is not desirable that the negative electrode mixture layer 29 is provided in all the odd-numbered layers.

Evaluation Results

Subsequently, results of the evaluation test for the cell 5 according to the first embodiment will be described. Nickel cobalt manganese oxide (NCM) was used for the positive electrode 1 (positive electrode active material). Carbon was used for the negative electrode 2 (negative electrode active material). A separator having a three-layer structure in which a polypropylene (PP) layer, a polyethylene (PE) layer, and a polypropylene (PP) layer were stacked was used as the separator 3. A capacity of cell 5 was 20 Ah. As the metal foreign matter, an L-shaped structure defined in IEC 62660-3, that is, an international standard for “safety requirements of secondary lithium-ion cells for EV application” was used. The size of the structure was 200 μm in height×2000 μm in length×100 μm in width. These test conditions were also common to an evaluation test (described later) of a second embodiment.

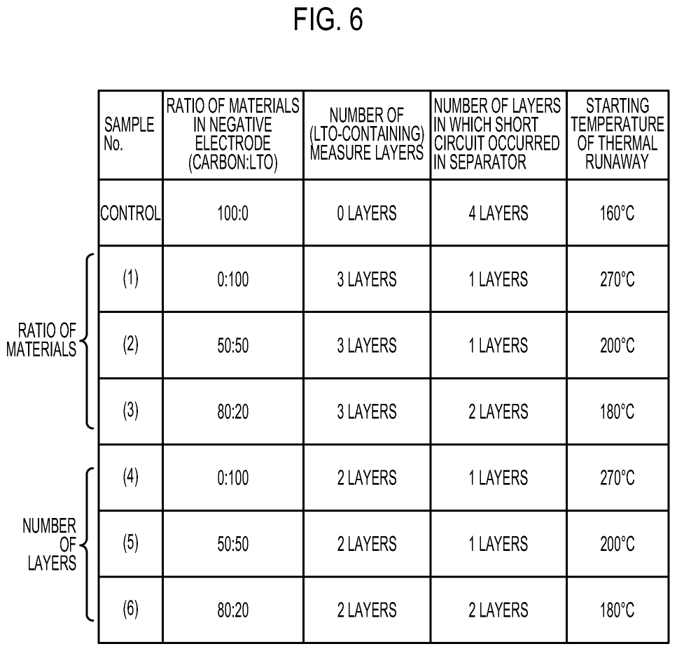

FIG. 6 is a table summarizing results of the evaluation test of the cell 5 according to the first embodiment. As shown in FIG. 6, six samples were prepared in this evaluation test. An LTO content in the negative electrode mixture layer 29 and/or the number of negative electrode mixture layers 29 containing LTO were different among these samples. The number of negative electrode mixture layers 29 is also referred to as “the number of measure layers” below.

For a control experiment, a sample with zero measure layers, that is, a sample with solely the negative electrode mixture layer 22 containing solely a graphite-based material was also prepared and evaluated. In the control sample, a short circuit occurred in the separator 3 of the four layers from the outermost layer (first layer to the fourth layer). An initial temperature at which heat was generated due to the short circuit (a temperature at which thermal runaway started) was 160° C.

Samples (1) to (3) were the same in that the number of measure layers was three, but differed from each other in the LTO contents. Therefore, the effect of the LTO content can be evaluated by comparing the samples (1) to (3). The LTO content of the sample (1) was 100%, the LTO content of the sample (2) was 50%, and the LTO content of the sample (3) was 20%.

The samples (1) and (2) having a relatively high LTO content had fewer layers in which a short circuit occurred in the separator 3 compared with the sample (3) having a relatively low LTO content. In addition, starting temperatures of thermal runaway were high in the order of the samples (1), (2), (3), that is, in the order of higher LTO content. The evaluation results show that the higher the LTO content, the more effective the prevention of a short circuit in the separator 3 and the more effective the suppression of heat generation in the separator 3.

The sample (1) and a sample (4) were the same in that the LTO content was 100%, but differed in that the sample (1) had three measure layers and the sample (4) had two measure layers. Similarly, the sample (2) and a sample (5) were the same in that the LTO content was 50%, but differed in that the sample (2) had three measure layers and the sample (5) had two measure layers. The sample (3) and a sample (6) were the same in that the LTO content was 20%, but differed in that the sample (3) had three measure layers and the sample (6) had two measure layers. Therefore, the effect of the number of measure layers can be evaluated by comparing the sample (1) and the sample (4), the sample (2) and the sample (5), and the sample (3) and the sample (6).

In all of the above three comparisons, the numbers of layers in which a short circuit occurred in the separator 3 were the same, and the starting temperatures of thermal runaway were also the same. The evaluation results show that the number of measure layers has almost no effect on the prevention of a short circuit and the suppression of heat generation in the separator 3.

As described above, in the first embodiment, the negative electrode 2A provided with the negative electrode mixture layer 29 mixed with LTO is disposed locally in the predetermined number of layers (the layer may be a single layer or a plurality of layers) including the outermost layer. Since the negative electrode mixture layer 29 contains LTO, the negative electrode mixture layer 29 exhibits higher electric resistance than the negative electrode mixture layer 22 containing solely a graphite-based material. Therefore, even when a short circuit occurs, a large short-circuit current is difficult to be transmitted. As a result, heat generation due to transmission of the short-circuit current can be suppressed, and thus thermal runaway of the cell 5 can be suppressed.

It is also considered that the measure to suppress the transmission of the short-circuit current is taken in all layers. However, when the measure is taken in all layers, the thickness of the electrode body 6 increases, so that the adverse effects, such as a decrease in an energy density or an increase in a size of the cell 5 may occur. In contrast, in the first embodiment, the layer containing LTO is limited to the outermost layer (several layers including the outermost layer). Therefore, the adverse effects, such as a decrease in an energy density or an increase in a size can be prevented.

### Second Embodiment

In the first embodiment, the example in which the measure is taken for the negative electrode 2 and LTO is adopted as the negative electrode active material is described. In the second embodiment, an example in which the measure is taken in the separator 3 will be described.

The non-aqueous electrolyte secondary battery according to the second embodiment is not limited to a lithium-ion secondary battery, and may be, for example, a sodium-ion secondary battery. Note that, a lithium-ion secondary battery will also be described as an example in the second embodiment. Since the overall configuration of the lithium-ion secondary battery according to the second embodiment is the same as the configuration shown in FIGS. 1 and 2, the description will not be repeated.

Configuration of Electrode Body

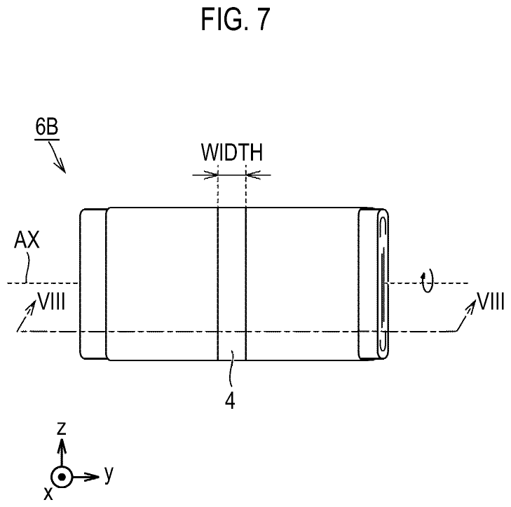

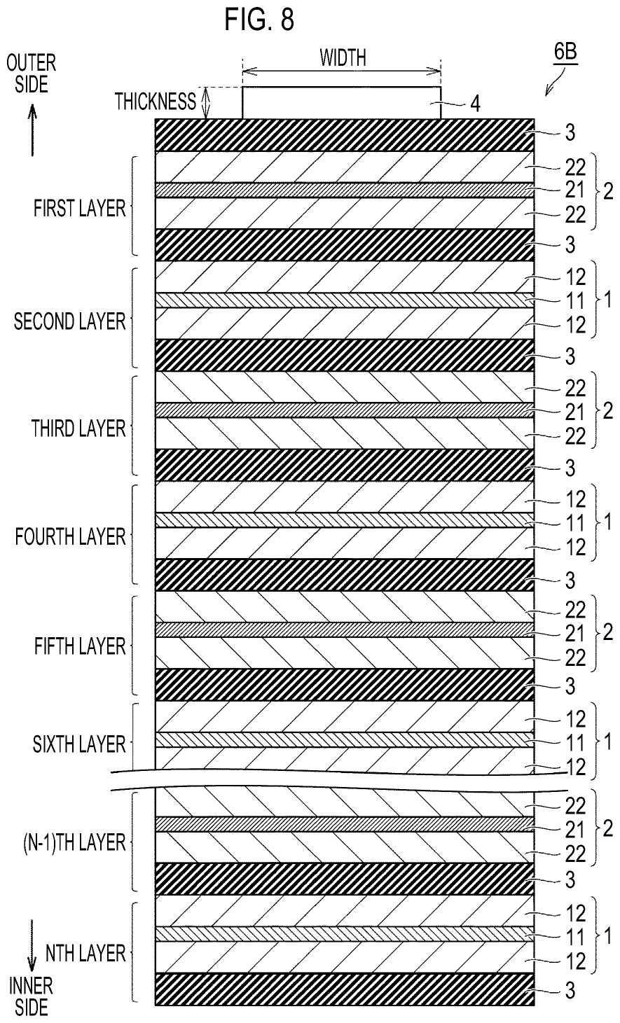

FIG. 7 is a view showing an example of the configuration of an electrode body according to a second embodiment. FIG. 8 is a view schematically showing a cross section of an electrode body 6B taken along the line VIII-VIII of FIG. 7. With reference to FIGS. 7 and 8, the electrode body 6B is different from the electrode body 6 (see FIGS. 3 to 5) in the first embodiment in that the electrode body 6B includes a heat resistance layer (HRL) 4 in a central portion of an outermost periphery thereof. The heat resistance layer 4 is locally provided in a central region of the electrode body 6B in the long side direction (y-direction) of the electrode body 6B. The reason is that a short circuit of the electrode body 6 is likely to occur particularly in the central region of the outermost peripheral portion where a load due to expansion and contraction of the electrode body 6 is concentrated. The heat resistance layer 4 corresponds to the “heat generation suppressing member” according to the present disclosure.

The heat resistance layer 4 has a structure for improving a heat resistance of the electrode body 6B, and includes a heat-resistant material. Specifically, the heat resistance layer 4 is, for example, a heat-resistant resin film. The heat resistance layer 4 may be a polyimide film (for example, Kapton tape (registered trademark)). The heat resistance layer 4 may be a heat-resistant insulating tape (for example, Nomex tape (registered trademark)) coated with a silicone-based or acrylic-based pressure-sensitive adhesive.

The heat resistance layer 4 may be an active material having high thermal stability (lithium titanate, lithium iron phosphate, or the like). Further, the heat resistance layer 4 may be well-known various heat-resistant materials, heat insulating materials, or heat-absorbing materials. As an example, ceramics (fine ceramics) having heat resistance, such as alumina (Al₂O₃) can be adopted.

The heat resistance layer 4 may be a region in which the same material as the other parts is used (that is, the material of the separator 3) and the thickness of the separator 3 is locally increased. Specifically, the separator 3 cut into small piece may be stacked on the normal separator 3 and adhere with an adhesive, tape, or the like.

Evaluation Results

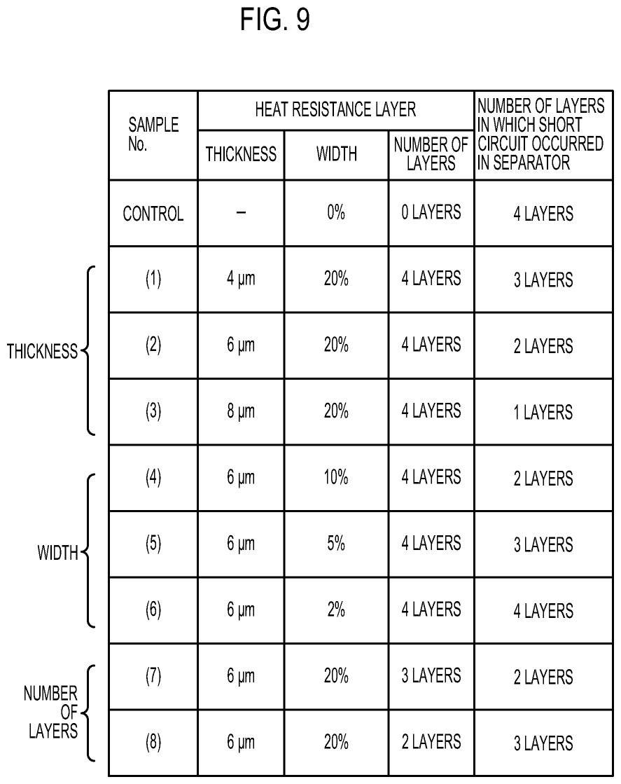

FIG. 9 is a table summarizing results of an evaluation test of a cell according to the second embodiment. With reference to FIG. 9, eight samples were prepared in this evaluation test. Between these samples, the thickness or width of the heat resistance layer 4 and/or the number of heat resistance layers 4 are different.

Also in the second embodiment, a control sample with zero heat resistance layers 4 was prepared. In the control sample, a short circuit occurred in the separator 3 of the four layers from the outermost layer (first layer to the fourth layer).

Samples (1) to (3) were the same in that the number of heat resistance layers 4 was four, and the width of the heat resistance layer 4 (the ratio of the width of the heat resistance layer 4 to the total width of the separator 3) was 20%. On the other hand, the samples (1) to (3) differed from each other in the thicknesses of the heat resistance layers 4. Therefore, the effect of the thickness of the heat resistance layer 4 can be evaluated by comparing the samples (1) to (3). The thickness of the heat resistance layer 4 provided in the sample (1) was 4 μm. The thickness of the heat resistance layer 4 provided in the sample (2) was 6 μm. The thickness of the heat resistance layer 4 provided in the sample (3) was 8 μm. FIGS. 7 and 8 can be referenced for the width and thickness of the heat resistance layer 4.

The numbers of layers in which a short circuit occurred in the separator 3 were small in the order of the samples (3), (2), (1), that is, in the order of thicker heat resistance layer 4. The evaluation results show that the thicker the heat resistance layer 4, the more effective the prevention of a short circuit in the separator 3.

Samples (4) to (6) were the same in that the number of heat resistance layers 4 was four, and the thickness of the heat resistance layer 4 was 6 μm. On the other hand, the samples (4) to (6) differed from each other in the widths of the heat resistance layers 4. Therefore, the effect of the width of the heat resistance layer 4 can be evaluated by comparing the samples (4) to (6). The width of the heat resistance layer 4 provided in the sample (4) was 10% of the total width of the separator 3. The width of the heat resistance layer 4 provided in the sample (5) was 5% of the total width of the separator 3. The width of the heat resistance layer 4 provided in the sample (6) was 2% of the total width of the separator 3.

The numbers of layers in which a short circuit occurred in the separator 3 were small in the order of the samples (4), (5), (6), that is, in the order of wider width of the heat resistance layer 4. The evaluation results show that the wider width of the heat resistance layer 4, the more effective the prevention of a short circuit in the separator 3.

The sample (2), the sample (7), and the sample (8) were the same in that the heat resistance layer 4 had a thickness of 6 μm and a width of 20%, but differed each other in the numbers of the heat resistance layers 4. Therefore, the effect of the number of heat resistance layers 4 can be evaluated by comparing the samples (2), (7), and (8). The number of heat resistance layers 4 provided in the sample (2) was four. The number of heat resistance layers 4 provided in the sample (7) was three. The number of heat resistance layers 4 provided in the sample (8) was two.

The samples (2) and (7) had fewer layers in which a short circuit occurred in the separator 3 compared with the sample (8). The evaluation results show that the prevention of a short circuit in the separator 3 is more effective when the number of heat resistance layers 4 is large to some extent (in this example, three or more layers).

As described above, in the second embodiment, the heat resistance layer 4 is added to the separator 3 constituting the predetermined number of layers including the outermost layer. In a case where the heat resistance layer 4 is provided, the electrode body 6 is less likely to be damaged by temperature rise even when the electrode body 6 generates heat caused by a short circuit in the electrode body 6, compared with a case where the heat resistance layer 4 is not provided. Further, the heat resistance layer 4 holds the electrolytic solution 7, so that the temperature of the electrode body 6 is less likely to rise. Therefore, thermal runaway of the electrode body 6B can be suppressed.

It is also considered that the measure that adds the heat resistance layer 4 is taken in all layers. However, when the measure is taken in all layers, the thickness of the electrode body 6B increases, so that the adverse effects, such as a decrease in an energy density or an increase in a size may occur. In contrast, in the second embodiment, a place where the heat resistance layer 4 is added is limited to the outermost layer (several layers including the outermost layer). Therefore, the adverse effects, such as a decrease in an energy density or an increase in a size can be prevented. Further, a decrease in ease of impregnation of the electrode body 6 with the electrolytic solution 7 (so-called fluidity) can be prevented by limiting the heat resistance layer 4 to the central region of the outermost peripheral portion of the electrode body 6.

In addition to the heat resistance layer 4, the electrode body 6B may be provided with the negative electrode 2A provided with the negative electrode mixture layer 29 mixed with LTO as in the first embodiment. In other words, the measure described in the first embodiment and the measure described in the second embodiment can be combined.

The embodiment disclosed herein is to be considered merely illustrative and not restrictive in all respects. The scope of the present disclosure is defined by the terms of the claims, rather than the above description of the embodiment, and is intended to include any modifications within the scope and meaning equivalent to the terms of the claims.

What is claimed is:

1. A non-aqueous electrolyte secondary battery comprising:
an electrode body in which a sheet-shaped positive electrode and a sheet-shaped negative electrode are stacked via a separator; and
a battery case that accommodates the electrode body and an electrolytic solution, wherein:
the electrode body includes
a predetermined number of outer layers including an outermost layer made up of the separator and the negative electrode disposed on an outermost side of the electrode body, and
an inner layer disposed on an inner side than the outer layer;
the outer layer includes a heat generation suppressing member configured to suppress heat generation of the electrode body caused by a short circuit of the electrode body; and
the inner layer does not include the heat generation suppressing member.

2. The non-aqueous electrolyte secondary battery according to claim 1, wherein:
the negative electrode includes a negative electrode body and a negative electrode mixture layer; and
the heat generation suppressing member includes the negative electrode mixture layer containing lithium titanium oxide.

3. The non-aqueous electrolyte secondary battery according to claim 1, wherein the heat generation suppressing member includes a heat resistance layer provided on the separator.

4. The non-aqueous electrolyte secondary battery according to claim 3, wherein:
the battery case is a square case;
the electrode body has an outer shape of a flat rectangular parallelepiped, and is accommodated in the battery case such that a long side of the flat rectangular parallelepiped extends in a long side direction of the battery case;
the heat resistance layer is locally provided in a central region of the electrode body in the long side direction of the electrode body.

5. The non-aqueous electrolyte secondary battery according to claim 4, wherein the heat resistance layer is a resin film having heat resistance.

6. The non-aqueous electrolyte secondary battery according to claim 4, wherein the heat resistance layer is a ceramic having heat resistance.

7. The non-aqueous electrolyte secondary battery according to claim 4, wherein the heat resistance layer is an active material containing at least one of lithium titanate and lithium iron phosphate.

8. The non-aqueous electrolyte secondary battery according to claim 4, wherein the heat resistance layer is an additional separator added to the central region.
